(19) United States
(12) Patent Application Publication
(10) Pub. No.: US 2012/0026839 A1
(43) Pub. Date: Feb. 2, 2012

(54) PEST-CONTROL DEVICE

(76) Inventor: Jonathan E. Levine, New York, NY (US)

(21) Appl. No.: 12/846,974

(22) Filed: Jul. 30, 2010

(51) Int. Cl. H04B 1/02

(52) U.S. Cl. 367/139

(57) ABSTRACT

A pest-control device that repels pests with sound is illustrated and described. The pest-control device can, for example, be plugged into a standard wall socket. Sound-transmission openings in the pest-control device can be positioned to selectively direct sound sideways along the wall including the socket. This can increase the effectiveness of the device at repelling pests in corners along the edges of floors and countertops, where pests tend to travel. The pest-control device also can include a light sensor that detects the ambient light level. An output volume can be permanently configured or temporarily configured to increase in response to a signal or absence of signal from the light sensor. For example, the pest-control device can be configured to increase the volume of pest-repelling sound at night when pests are most active and people and pets typically are not present.

### FIELD

This disclosure concerns pest-control devices, such as pest-control devices that repel pests with sound.

### BACKGROUND

Most known products used to control household pests (e.g., rodents and large insects) work by killing the pests with poison or traps. Use of these products can create a risk of inadvertent injury to humans and pets as well hygiene problems associated with the disposal of dead pests. Considering these significant disadvantages, devices that repel pests rather than killing them offer an attractive alternative. Pest-control devices that repel pests with sound waves are particularly advantageous. Sound-wave pest-control devices pose no danger to humans and pets and are completely humane and hygienic. They work by emitting sound waves that make an environment hostile to pests. Large pests typically have higher upper thresholds of audible frequencies than humans, cats, and dogs. Therefore, when operating at high frequencies, sound-wave pest-control devices can be effective while remaining inaudible or only slightly audible to humans and pets.

### SUMMARY

Disclosed herein are embodiments of a pest-control device that repels pests with sound. Some embodiments include a speaker that emits a pest-repelling sound, such as a pest-repelling sound including both sonic and ultrasonic frequencies. The speaker can be enclosed within a frame. Power can be provided through an electrical plug compatible with a standard wall socket. The connection between the electrical plug and a portion of the pest-control device including the speaker (e.g., the frame) can be substantially rigid. For example, some disclosed embodiments can be suspended adjacent to a vertical wall by inserting the electrical plug into a standard electrical socket within the vertical wall. When positioned in this manner, with the electrical plug inserted into a standard electrical socket within a vertical wall, the pest-control device can have a side surface substantially perpendicular to the vertical wall. The pest-control device also can have a front surface substantially perpendicular to the side surface. One or both of the side surface and the front surface can include at least one sound-transmission opening. Some disclosed embodiments have two side surfaces substantially perpendicular to the vertical wall, both of which can include at least one sound-transmission opening.

Embodiments of the disclosed pest-control device can include a light sensor, such as a light sensor configured to receive light through an opening in the top surface of the pest-control device. In some disclosed embodiments, the pest-control device is permanently configured or temporarily configured to increase an output volume from the speaker in response to a signal or absence of signal from the light sensor. Embodiments that can be temporarily configured to increase an output volume from the speaker in response to a signal or absence of signal from the light sensor can, for example, include a switch or potentiometer operable from an external portion of the pest-control device. The setting of the switch or potentiometer can determine whether or a degree to which the output volume from the speaker is increased in response to the signal or absence of signal from the light sensor. The signal or absence of signal from the light sensor can indicate, for example, low light relative to a threshold level of light.

### BRIEF DESCRIPTION OF THE DRAWINGS

FIG. 1 is a perspective view of one embodiment of the disclosed pest-control device.

FIG. 2 is a front profile view of the pest-control device embodiment shown in FIG. 1.

FIG. 3 is a side profile view of the pest-control device embodiment shown in FIG. 1.

FIG. 4 is a bottom plan view of the pest-control device embodiment shown in FIG. 1.

FIG. 5 is a back profile view of the pest-control device embodiment shown in FIG. 1.

FIG. 6 is a top plan view of the pest-control device embodiment shown in FIG. 1.

FIG. 7 is a perspective view of the inside of the front portion of the frame of the pest-control device embodiment shown in FIG. 1.

FIG. 8 is a circuit diagram corresponding to the electronics of the pest-control device embodiment shown in FIG. 1.

### DETAILED DESCRIPTION

Throughout this disclosure, the singular terms “a,” “an,” and “the” include plural referents unless the context clearly indicates otherwise. Similarly, the word “or” is intended to include “and” unless the context clearly indicates otherwise. Directional terms, such as “upper,” “lower,” “front,” “back,” “vertical,” and “horizontal,” are used herein to express and clarify the relationship between various elements. It should be understood that such terms do not denote absolute orientation (e.g., a “vertical” component can become horizontal by rotating the device).

Disclosed herein are embodiments of a pest-control device that uses sound waves to repel pests. Some embodiments of the disclosed pest-control device include one or more features to at least partially address deficiencies of conventional sound-wave pest-control devices. For example, conventional sound-wave pest-control devices often have a limited range because sound waves do not travel well through solid objects, such as walls and furniture. As a competing factor, the output of conventional sound-wave pest-control devices often is slightly audible to humans and pets and can be an annoyance. Increasing the volume of pest-repelling sound can increase the effective range, but also typically increases audibility to humans and pets.

Embodiments of the disclosed pest-control device can be configured to distribute sound more efficiently than conventional sound-wave pest-control devices. Pests, particularly rodents, often have an instinctive tendency to travel along corners where floors or countertops meet walls. Some embodiments of the disclosed pest-control device include sound-transmission openings positioned to selectively direct sound waves in these areas. For example, some embodiments of the disclosed pest-control device can be plugged into and suspended from a standard wall socket and can emit sound from openings positioned in side surfaces substantially perpendicular to the wall including the socket. Since sockets typically are placed near a floor or countertop, these embodiments are able to emit sound waves directly along the lower portion of a wall and the adjacent edge of a floor or countertop.

Embodiments of the disclosed pest-control device also can be configured to change the output volume according to the ambient light level. For example, when the ambient light level is low, the output volume can be increased. Pests typically are most active in darkness. Humans and pets typically are not present in dark areas other than bedrooms. If humans and pets are not present in an area, the output volume can be increased to improve the effectiveness of the device without regard to increasing the audibility to humans and pets. Automatically changing the output volume in response to the ambient light level, however, is not always desirable. For example, bedrooms are typically occupied when dark, so audibility by humans and pets is a concern regardless of the ambient light level. Therefore, embodiments capable of changing the output volume according to the ambient light level also can be configured to allow an end user to turn this feature on or off or to control the amount of volume amplification.

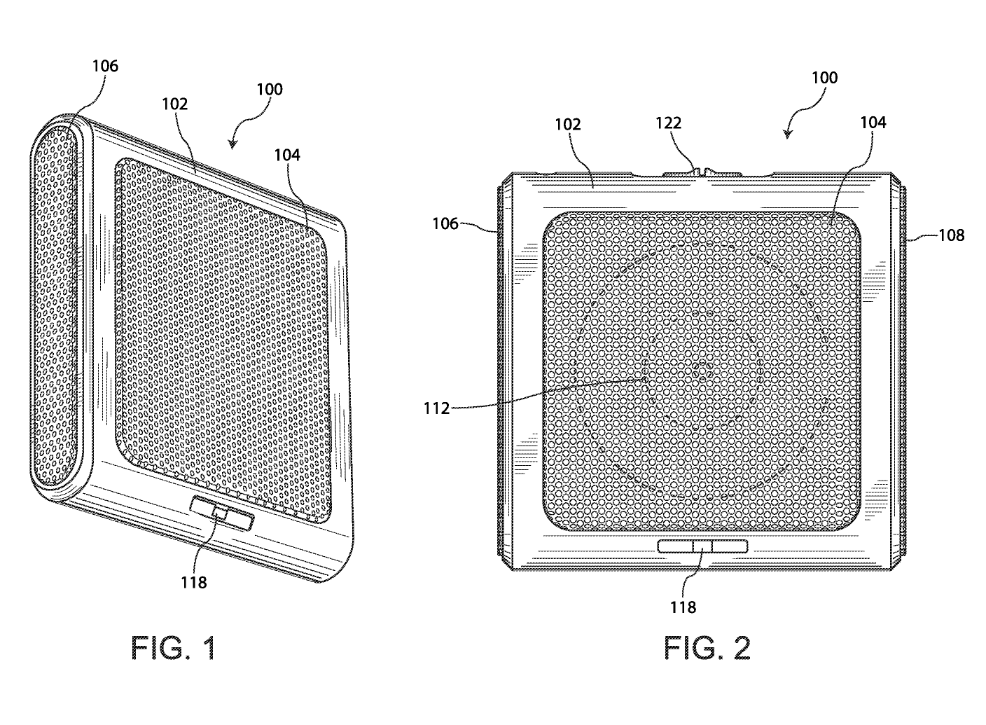

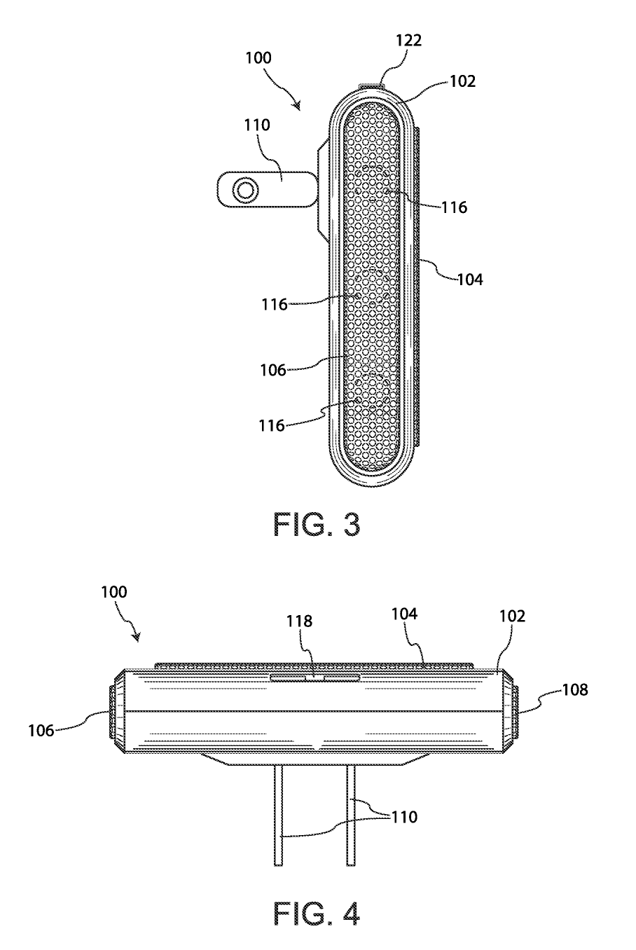

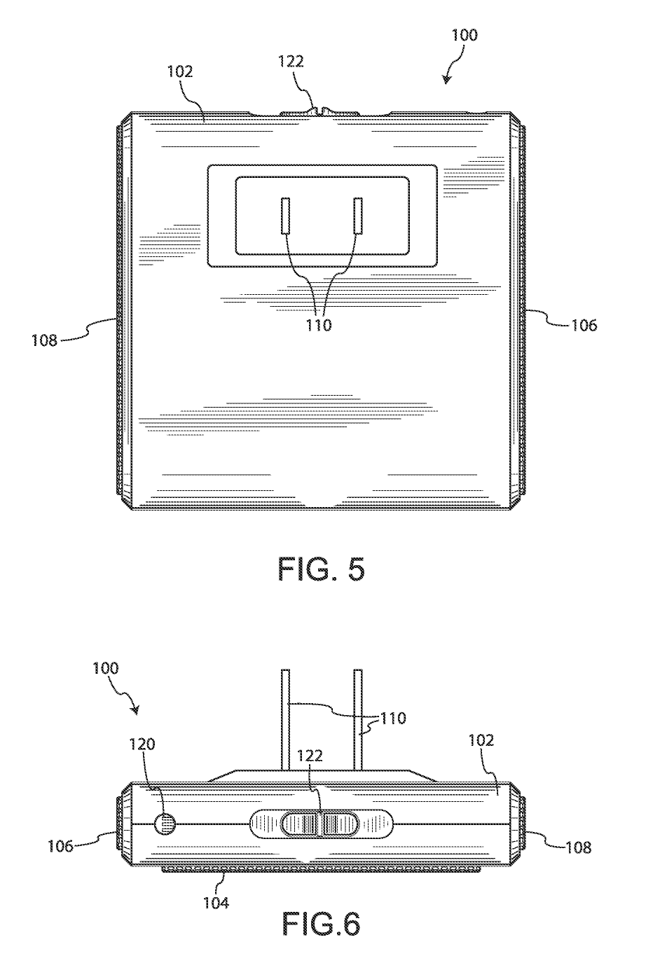

FIGS. 1-8 illustrate an embodiment of the disclosed pest-control device. As best shown in FIGS. 1 and 2, the pest-control device 100 includes a frame 102 having a front grill 104, a first side grill 106, and a second side grill 108. As shown in FIGS. 3-6, a plug 110 extends from the back surface of the frame 102. A speaker 112 and a circuit board (not shown) are positioned within the frame 102. In FIG. 2, the speaker 112 is partially visible through openings in the front grill 104. The overall pest-control device 100 is substantially shaped as a rectangular prism with rounded top and bottom edges. Other embodiments can have different shapes, but typically are compact. The pest-control device 100 is compact enough to be entirely suspended from the plug 110 when the plug is inserted into a standard wall socket. When the plug 110 is inserted into a standard wall socket, the pest-control device 100 projects less than one inch from the wall surrounding the socket.

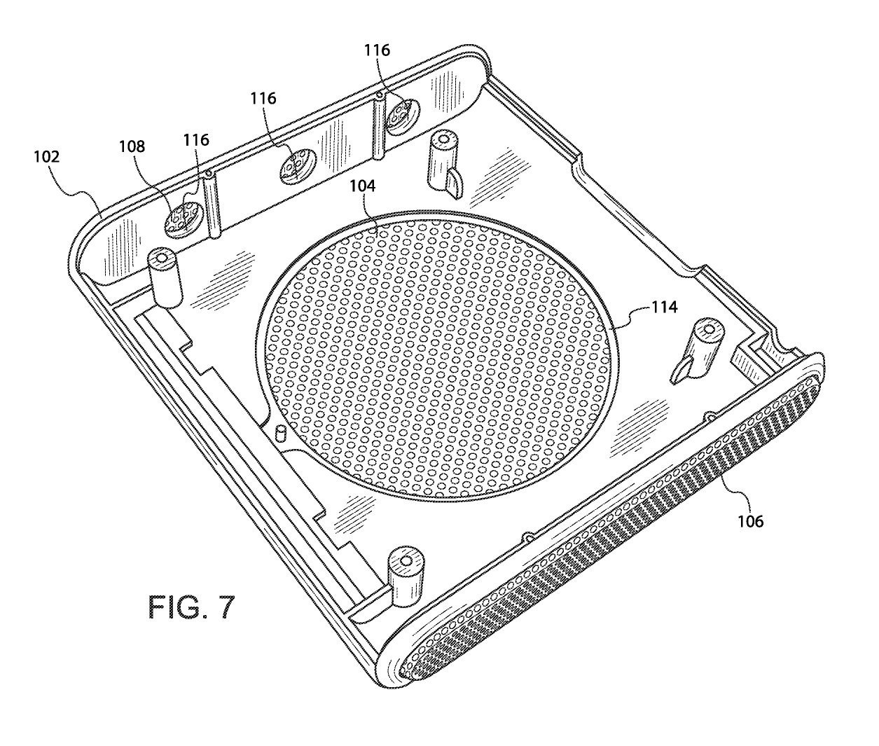

Some embodiments of the disclosed pest-control device include sound-transmission openings that facilitate sound transmission out of the frame. In general, the sound-transmission openings are portions of the frame through which sound can pass more efficiently relative to other portions of the frame. FIG. 7 is a perspective view of the inside of a front portion of the frame 102 of the illustrated pest-control device 100. As shown in FIG. 7, the frame 102 includes a front sound-transmission opening 114 behind the front grill 104 and three side sound-transmission openings 116 behind the second side grill 108. Although not visible in FIG. 7, an additional three side sound-transmission openings 116 are positioned behind the first side grill 106. The side sound-transmission openings 116 behind the first side grill 106 are partially visible in FIG. 3 through perforations in the first side grill. The positions of the front and side sound-transmission openings 114, 116 help to direct sound out of the frame 102 with some selectivity. The side sound-transmission openings 116 are positioned in side surfaces substantially perpendicular to the surface in which the front sound-transmission opening 114 is positioned. When the plug 110 is inserted into a standard wall socket, the side surfaces are substantially perpendicular to the wall surrounding the socket. Thus, the side sound-transmission openings 116 are well positioned to direct sound horizontally along the wall surrounding the socket, particularly at and near the vertical position of the socket.

The configuration of grills and sound-transmission openings can be different in different embodiments of the disclosed pest-control device. For example, some disclosed embodiments include no grills and, instead, have exposed sound-transmission openings in portions of the frame. These exposed sound-transmission openings are typically smaller than the front and side sound-transmission openings 114, 116 of the illustrated pest-control device 100. The sound-transmission openings in other embodiments of the disclosed pest-control device can have various positions around the frame. For example, some embodiments of the disclosed pest-control device include one or more sound-transmission openings in the front surface only, in the side surfaces only, or in one side surface and not the other. Embodiments of the disclosed pest-control device also can include sound-transmission openings in the top and/or bottom surfaces of the device.

In the illustrated pest-control device 100, the frame 102 is made of molded plastic and the front grill 104 and the first and second side grills 106, 108 are made of perforated metal. In other embodiments, the frame and grills can be made of different materials. For example, the frame can be made of metal and the grills can be made of cloth. Portions of the frame around the sound-transmission openings can be sound insulated (e.g., with foam) to increase the selectivity by which sound is emitted through the sound-transmission openings.

When the plug 110 is inserted into a standard wall socket, the speaker 112 automatically begins emitting pest-repelling sound and an indicator light 118 illuminates. Since the pest-repelling sound is inaudible or only slightly audible to humans, the indicator light 118 is useful to indicate that the device is active. The pest-repelling sound emitted by embodiments of the disclosed pest-control device can be sonic, subsonic, ultrasonic, or a combination thereof. To prevent pests from becoming acclimated to a given sound frequency, embodiments of the disclosed pest-control device can be configured to emit different frequencies. For example, some embodiments of the disclosed pest-control device are configured to emit pest-repelling sound including both sonic and ultrasonic frequencies. The emitted frequencies can change randomly or according to a set pattern. For example, an emitted frequency can be randomly selected from a set of known pest-repelling frequencies and emitted for a randomly selected time interval. Embodiments of the disclosed pest-control device also can be programmed to emit conventional pest-repelling sound-wave patterns.

The pest-control device 100 operates at one of two volume settings according to the ambient light level. A light sensor 120 positioned on the top surface of the pest-control device 100 detects whether the ambient light level is above or below a threshold value. If the ambient light level is above the threshold value, the speaker 112 emits pest-repelling sound at a daytime volume. If the ambient light level is below the threshold value, the speaker 112 emits pest-repelling sound at a nighttime volume. Positioning the light sensor 120 on the top surface of the pest-control device 100 is useful because it typically does not fall within a shadow that could prevent it from accurately detecting the ambient light level.

In the pest-control device 100, the nighttime volume is greater than the daytime volume. In other disclosed embodiments, the daytime volume can be greater than the nighttime volume. The daytime volume of the pest-control device 100 is set at a predetermined level of acceptable audibility to humans and pets. A nighttime-volume control 122 positioned on the top surface of the pest-control device 100 determines whether or the degree to which the nighttime volume is greater than the daytime volume. When the nighttime-volume control 122 is at its minimum setting, the nighttime volume is the same as the daytime volume. Increasing the setting on the nighttime-volume control 122 increases the nighttime volume without affecting the daytime volume. When the nighttime-volume control 122 is at its maximum setting, the nighttime volume is increased to its maximum level so that the pest-repelling sound has its maximum effectiveness, but is distinctly audible to humans and pets.

Some embodiments of the disclosed pest-control device do not include a nighttime-volume control or include a different type of nighttime-volume control than the nighttime-volume control 122 of the pest-control device 100. For example, some disclosed embodiments switch between a set daytime volume and a set nighttime volume automatically without allowing modification of the functionality by an end user. Other embodiments include a switch to turn the functionality on or off, but do not allow an end user to control the exact difference between the daytime volume and the nighttime volume. Still other embodiments include a switch with several set positions corresponding to levels of difference between the daytime volume and the nighttime volume. For example, such a switch can include an “off” setting in which the daytime volume is the same as the nighttime volume, a “low” setting in which the nighttime volume is slightly greater than the daytime volume, and a “high” setting in which the nighttime volume is significantly greater than the daytime volume. Like the nighttime volume, the daytime volume can be set, as it is in the pest-control device 100, or controllable by an end user, such as by any of the mechanisms previously described with regard to the nighttime volume.

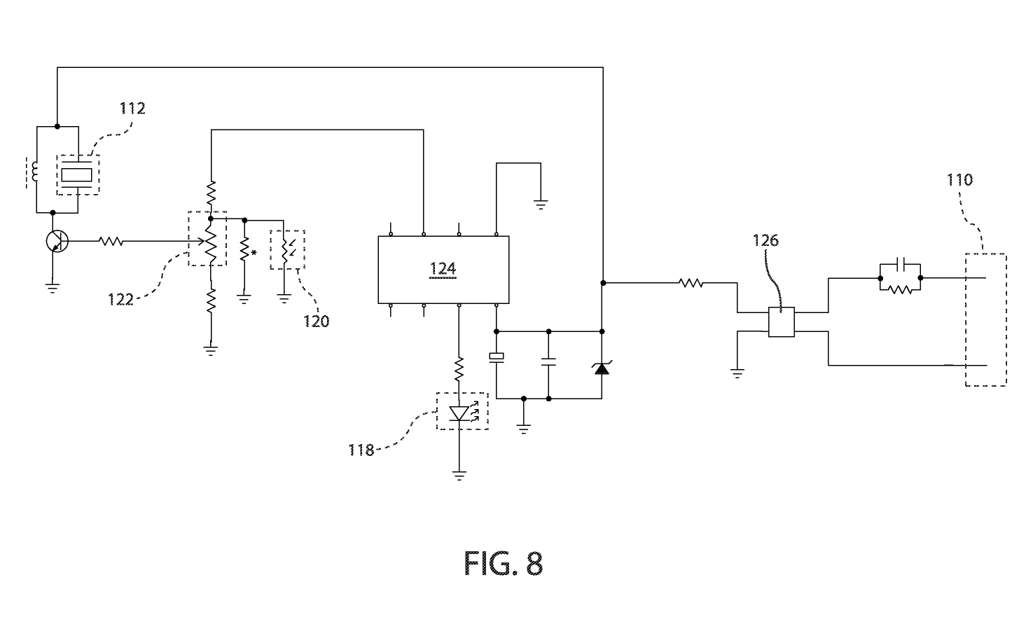

FIG. 8 is a circuit diagram corresponding to the pest-control device 100. The symbols corresponding to the plug 110, the speaker 112, the indicator light 118, the light sensor 120, and the nighttime-volume control 122 are indicated with dashed boxes and the appropriate reference numerals. As shown in FIG. 8, the nighttime-volume control 122 includes a potentiometer and the indicator light 118 includes a light-emitting diode. The illustrated standard electrical components are commercially available. In addition to the standard electrical components, the circuit diagram includes a first integrated circuit 124 and a second integrated circuit 126. The first and second integrated circuits 124, 126 are designed with appropriate logic and memory components. In the pest-control device 100, the electrical components shown in FIG. 8 are located within or directly connected to a circuit board (not shown) positioned within the frame 102. The potentiometer of the nighttime-volume control 122 is connected to an external slider. In other embodiments, the nighttime-volume control 122 can include a different type of external mechanism, such as a dial or a flip switch.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A pest-control device, comprising:
a speaker;
an electrical plug compatible with a standard wall socket; and
a light sensor, wherein the pest-control device is permanently configured or can be temporarily configured to increase an output volume from the speaker in response to a signal or absence of signal from the light sensor.

2. The pest-control device according to claim 1, wherein the pest-control device is configured to emit pest-repelling sound including both sonic and ultrasonic frequencies.

3. The pest-control device according to claim 1, wherein the pest-control device has a front surface and a side surface, the front surface is substantially perpendicular to the side surface, and the front surface and the side surface each include at least one sound-transmission opening.

4. The pest-control device according to claim 1, wherein the connection between the electrical plug and a portion of the pest-control device including the speaker is substantially rigid.

5. The pest-control device according to claim 1, wherein the pest-control device can be suspended adjacent to a vertical wall by inserting the electrical plug into a standard electrical socket within the vertical wall.

6. The pest-control device according to claim 5, wherein the pest-control device has a side surface substantially perpendicular to the vertical wall when the pest-control device is suspended adjacent to the vertical wall with the electrical plug inserted into the standard electrical socket within the vertical wall, and the side surface includes at least one sound-transmission opening.

7. The pest-control device according to claim 5, wherein the pest-control device has a top surface when the pest-control device is suspended adjacent to the vertical wall with the electrical plug inserted into the standard electrical socket within the vertical wall, and the light sensor is configured to receive light through an opening in the top surface.

8. The pest-control device according to claim 1, further comprising a switch or potentiometer operable from an external portion of the pest-control device, wherein the setting of the switch or potentiometer determines whether or a degree to which the output volume from the speaker is increased in response to the signal or absence of signal from the light sensor.

9. The pest-control device according to claim 8, wherein the setting of the switch or potentiometer determines whether or the degree to which the output volume from the speaker is increased in response to the signal or absence of signal from the light sensor indicating low light relative to a threshold level of light.

10. The pest-control device according to claim 8, wherein the switch or potentiometer is a potentiometer.

11. The pest-control device according to claim 10, wherein the setting of the potentiometer determines the degree to which the output volume from the speaker is increased in response to the signal or absence of signal from the light sensor indicating low light relative to a threshold level of light.

12. A pest-control device, comprising:
a speaker;
an electrical plug compatible with a standard wall socket; and
a frame at least partially enclosing the speaker, wherein the frame has a first side surface and a second side surface, the first and second side surfaces of the frame are configured to be substantially perpendicular to an external wall when the electrical plug is inserted into a standard electrical socket within the external wall, the first side surface and the second side surface of the frame each include at least one opening configured to transmit sound from the speaker, and the electrical plug is rigidly connected to the frame.

13. The pest-control device according to claim 12, wherein the pest-control device is configured to emit pest-repelling sound including both sonic and ultrasonic frequencies.

14. The pest-control device according to claim 12, further comprising a light sensor, wherein the pest-control device is permanently configured or can be temporarily configured to increase an output volume from the speaker in response to a signal or absence of signal from the light sensor.

15. The pest-control device according to claim 14, wherein the frame has a top surface configured to be substantially perpendicular to the external wall when the electrical plug is inserted into the standard electrical socket within the external wall, and the light sensor is configured to receive light through an opening in the top surface.

16. The pest-control device according to claim 14, further comprising a switch or potentiometer operable from an external portion of the pest-control device, wherein the setting of the switch or potentiometer determines whether or a degree to which the output volume from the speaker is increased in response to the signal or absence of signal from the light sensor.

17. The pest-control device according to claim 16, wherein the setting of the switch or potentiometer determines whether or the degree to which the output volume from the speaker is increased in response to the signal or absence of signal from the light sensor indicating low light relative to a threshold level of light.

18. The pest-control device according to claim 16, wherein the switch or potentiometer is a potentiometer.

19. The pest-control device according to claim 18, wherein the setting of the potentiometer determines the degree to which the output volume from the speaker is increased in response to the signal or absence of signal from the light sensor indicating low light relative to a threshold level of light.

20. A pest-control device, comprising:
a speaker;
an electrical plug compatible with a standard wall socket;
a light sensor; and
means for increasing an output volume from the speaker in response to an ambient light level falling below a threshold value.
